(19) United States
(12) Patent Application Publication
(10) Pub. No.: US 2010/0202927 A1
(43) Pub. Date: Aug. 12, 2010

(54) MULTI-WELL PLATE LID WITH PROTECTIVE SKIRT

(75) Inventors: Paul J. Queeney, San Diego, CA (US); Rose Hughes, San Diego, CA (US)

Correspondence Address: GLOBAL PATENT GROUP - KAL, 1005 North Warson Road, Suite 201, St. Louis, MO, 63132, US

(73) Assignee: KALYPSYS, INC., San Diego, CA (US)

(21) Appl. No.: 12/524,716

(22) PCT Filed: Jan. 11, 2008
(86) PCT No.: PCT/US08/50909

§ 371 Date: Mar. 22, 2010

Related U.S. Application Data
(60) Provisional application No. 60/886,804, filed on Jan. 26, 2007.

(51) Int. Cl. B01L 3/00

(52) U.S. Cl. 422/99

(57) ABSTRACT

A plate lid for covering a multi-well plate for use in a high throughput screening (HTS) process. The lid includes a plate section dimensioned to cover the plate, a frame block positioned on the underside perimeter of the plate section to form a recessed center, a skirt section protruding from each edge of the frame block; and a gasket layer positioned on the frame block for sealing the peripheral surface of the multi-well plate.

This application claims the benefit of priority of U.S. provisional application No. 60/886,804, filed Jan. 26, 2007, the disclosure of which is hereby incorporated by reference as if written herein in its entirety.

### FIELD OF THE INVENTION

The present invention is directed to covers for use on multi-well plates. More specifically, the present invention relates to an improved multi-well plate lid with protective skirt to cover microtitre plates of various standard sizes ranging from 12 to 3456 wells.

### BACKGROUND OF THE INVENTION

In recent years, there has been a growing trend towards more frequent use of cell-based assays for drug discovery. Cell-based assays are an important tool in a high throughput screening (HTS) process, where it is desirable to analyze tens of thousands or more samples per day. Due to the costs of reagents and cells, cell-based assays have been miniaturized and increasingly performed in microtitre plates. Each cuvette in, e.g., a 1536-well microtitre plate, can accommodate a maximum well volume of 12 μL to 15 μL, while a typical assay volume ranges from 3 μL to 7 μL.

Several factors arc known to increase the noise and variability of cell-based assays used for HTS. In particular, edge effects can result in an unacceptably high plate rejection rate in screening runs due to evaporation of samples from the edge wells, or uneven evaporation of samples from around the edge of the microtitre plate. In an effort to minimize such egression, it is known to provide a lid to cover the microtitre plate to reduce loss of volume due to evaporation or sublimation.

An example of the plate lid can be found in U.S. Pat. No. 6,534,014 entitled “Specimen Plate Lid and Method of Using” issued Mar. 18, 2003; the disclosures of which are incorporated therein by reference. Such plate lid suffers deficiencies in that the sealing gasket, which is made of a highly compliant material, can he deformed, e.g., to cause the lid to separate from the plate, thereby allowing evaporation leakage and inadequate sealing to occur.

### SUMMARY OF THE INVENTION

The subject invention is directed to solving the foregoing problems of the existing art. In accordance with an exemplary embodiment of the present invention, there is provided a plate lid for covering a multi-well plate, which includes a plate section dimensioned to cover the plate, a frame block positioned on the underside perimeter of the plate section to form a recessed center, a skirt section protruding from each edge of the frame block; and a gasket layer positioned on the frame block for sealing the peripheral surface of the multi-well plate.

Particularly, the plate section can have a series of through holes arranged in a matrix-like manner to allow exchange of gas in a uniform manner.

The invention described herein is particularly adapted to work with robotic systems, which can use mechanical devices to secure the cover, apply it to a multi-well plate, and remove the cover as needed.

These and other features and advantages of the present invention will be appreciated from review of the following detailed description of the invention, along with the accompanying figures in which like references numerals refer to like parts throughout.

### BRIEF DESCRIPTION OF THE DRAWINGS

FIG. 1 is a perspective view of a multi-well plate lid positioned over a multi-well plate according to an exemplary embodiment;

FIG. 2 is a perspective view of an underside of the multi-well plate lid as shown in FIG. 1;

FIG. 3 is a bottom plan view of the multi-well plate lid as shown in FIG. 1;

FIG. 4 is an elevated side view of the multi-well plate lid as shown in FIG. 1;

FIG. 5 is a top view of a multi-well plate lid according to another exemplary embodiment; and

FIG. 6 is an illustration of an alternative fitting configuration for a sealing gasket layer and frame block in the multi-well plate lid as shown in FIG. 1.

### DETAILED DESCRIPTION OF THE EXEMPLARY EMBODIMENT

Referring now more particularly to the drawings, FIG. 1 illustrates an exemplary embodiment of a multi-well plate lid 10, which is positioned over a multi-well plate 12. The lid 10 is dimensioned to cover the plate 12, and can be made from stainless steel, moldable polymer plastic, or other suitable materials which can hold shape under certain environmental conditions inside an incubator, or satisfy user defined characteristics such as weight and durability, and have certain degree of chemical resistance to solvents. In the exemplary embodiment, the lid 10 weighed approximately 8.9 oz (251 g), but it will be appreciated that other weights can be incorporated to ensure that an effective seal can be accomplished between the lid 10 and the plate 12.

One or more alignment tabs 14 are configured on the lid 10 to facilitate cooperation between the lid 10 and the plate 12. The alignment tabs 14 are configured with such tolerance so that they do not create friction with the sidewalls of the plate 12, and that they can be easily placed or removed by a robotic arm. Tolerances for the alignment tabs are generally set at a range between 0.1 mm to 0.2 mm, with a preferred range set at 0.13 mm. Such range of tolerances allows for an easy mounting or dismounting of the tray by a robotic arm, and avoids unwanted wear and tear on the plate.

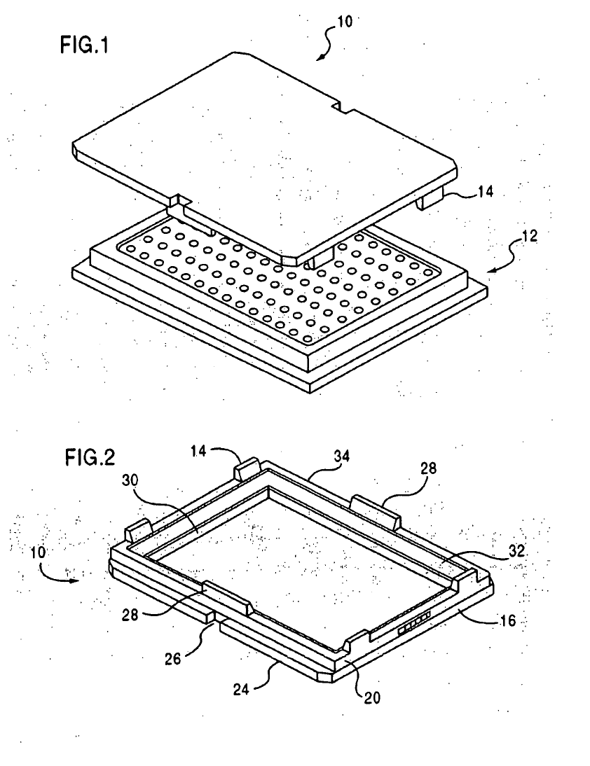

FIG. 2 is a perspective view of the lid 10 showing its underside. Particularly, the lid 10 includes a flat plate section 16. Sidewalls 20 at the perimeter of the flat plate section 16 extend downward to form a recessed center therein. One set of the opposing side walls 20 is positioned closer to the recessed center as to create extended edge portions 24. Each of the extended edge portions 24 has a center recess 26 to accommodate a guide tab 28, which is used to mate with a mechanical device, such as the delidding station, so that a robotic arm can be utilized to remove and replace the lid 10.

A frame block 30 is set on the flat plate section 16 along the perimeter but within the sidewalls 20 to support a sealing gasket layer 32, which is securely placed thereon. The width of each opposing side of the frame block 30 can be the same or different from one another, depending on the predetermined width of the plate 12. The size of the gasket layer 32 is made similar to the frame block 30, but the position of the gasket layer 32 is made lower than the sidewalls 20 so as to create a skirt section 34 which can block air flow or prevent gas from escaping the plate when the lid is engaged. The gasket layer 32 can be of a thickness that ranges from 0.0312 inches to 0.0625 inches, and a width that ranges from 3.57 mm to 6.63 mm. In a preferred embodiment, the gasket layer 32 is flat to avoid distortion when engaged with the plate 12. The gasket layer 32 can be made from a material chosen from a group consisting of viton rubber, silicon rubber, and buna rubber. The gasket layer can also have a durometer value in the range of 20 A to 75 A, and a minimum tensile strength of 900 PSI or in the range of 900 PSI to 2500 PSI. In a preferred embodiment, the gasket layer 32 should be made from noncompliant or incompressible material to avoid deformity thereto when engaged with the plate 12.

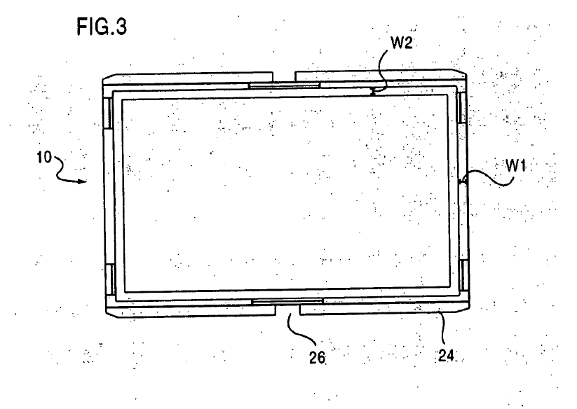

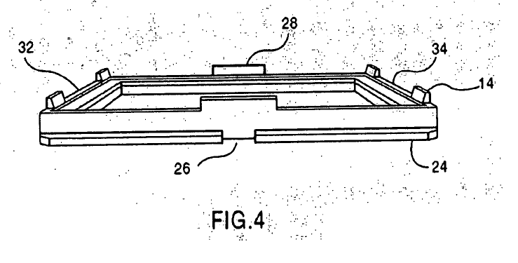

FIG. 3 is a bottom view of the lid 10 according to the exemplary embodiment. The gasket layer 32 can have a thickness (T) that ranges from 0.0312 inches to 0.0625 inches, and a width (W) that ranges from 3.57 mm to 6.63 mm. For instance, the first width (W1) of the first opposing sides of the gasket layer as shown in FIG. 3 is 6.63 mm while the second width (W2) of the other opposite sides of the gasket layer is 3.57 mm. It will be appreciated that the first width (W1) and second width (W2) can also be the same, and that the gasket layer 32 can be of a uniform thickness.

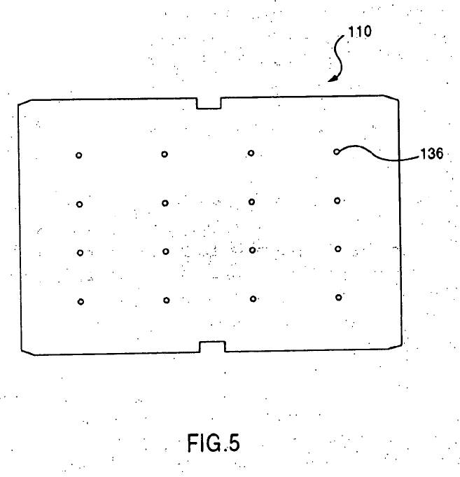

FIG. 4 is an elevated side view of the lid 10 according to the exemplary embodiment. Unlike conventional plate covers where evaporation is pronounced at the edges of the multi-well plate, the difference in height between the gasket layer 32 and the side walls formed the skirt section 34 blocks air from escaping, thereby minimizing evaporation to take place at the edges of the plate. Additionally, the number and position of each alignment tabs 14 and guiding tabs 28 can be varied depending upon the size and shape of the multi-well plate.

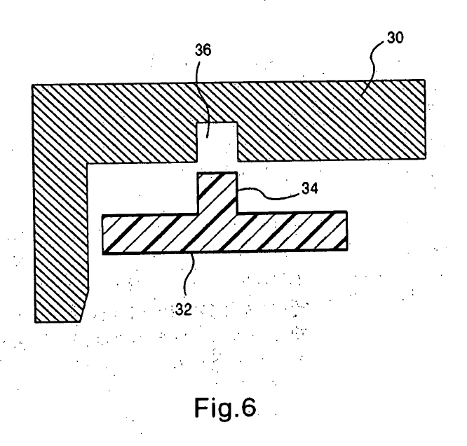

FIG. 5 is a top view of a lid 110 according to an alternative embodiment. One or more through holes 136 in a matrix-like pattern can be arranged on the plate 110 to allow internal gases between the lid 110 and the plate 12 to be exchanged with external gas, e.g., CO₂, from an external environment, particularly when stored in an incubator. Evaporation at the through holes is relatively minimal as compared to potential evaporation at the edges of the plate 12, and such minimum evaporation is evenly or uniformly distributed.

The gasket layer 32 as shown in FIGS. 1-4 can be titled onto the frame block through a variety of ways, such as adhesive or friction fitting. Optionally, to provide more secure fit between the frame block 30 and gasket layer 32, the gasket layer 32 can have a protrusion 34 that mates with a corresponding recess moat 36 on the frame block 30 as shown in FIG. 6.

Other than the gasket layer 32, the lid 10 can be of a single unitary construction made from a plastic or steel molding. Such lid would integrate the alignment tabs 14, flat plate section 16, side walls 20, extended edge portions 24, guiding tabs 28, frame block 30, and skirt sections 34 to form a single unitary body. The gasket layer 32 can thereafter be securely placed onto the frame block 30 through adhesive means. Through holes on the flat plate section can also be made through drilling means if needed.

Having now described an exemplary embodiment of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, equivalents or similar purpose, unless expressly stated otherwise. Therefore, numerous other embodiments of the modifications thereof are contemplated as falling within the scope of the present invention as defined by the appended claims and equivalents thereto.

What is claimed is:

1. A lid for covering a multi-well plate comprising:
a plate section dimensioned to cover said multi-well plate;
a frame block positioned on the underside perimeter of said cover plate to form a recessed center;
a skirt section protruding from each edge of said frame block; and
a gasket layer positioned on said frame block for sealing the peripheral surface of the multi-well plate.

2. The lid as recited in claim 1, further comprising a plurality of guiding tabs protruding from said skirt section.

3. The lid as recited in claim 1, wherein said skirt section is taller than said gasket layer to form a protective wall and provide air flow blockage.

4. The lid as recited in claim 1, wherein said gasket is made of a noncompliant or incompressible material.

5. The lid as recited in claim 1, wherein said gasket is formed of a material chosen from a group consisting of viton rubber, silicon rubber, and buna rubber.

6. The lid as recited in claim 1, wherein said gasket layer is attached to said frame block through adhesive.

7. The lid as recited in claim 1, wherein said gasket layer is fitted onto said frame through friction.

8. The lid as recited in claim 1, wherein said gasket layer has a thickness that ranges from 0.0312 inches to 0.0625 inches.

9. The lid as recited in claim 1, wherein said gasket layer is flat and rectangular.

10. The lid as recited in claim 1, wherein the plate section has a plurality of through holes arranged in a matrix-like manner to allow gas exchange in a uniform manner.

11. The lid as recited in claim 1, wherein said gasket has a durometer value in the range of 20 A to 75 A, or a minimum tensile strength of 900 PSI.

12. A lid for covering a multi-well plate comprising:
a plate section dimensioned to cover said multi-well plate;
a frame block positioned on underside perimeter of said plate section to form a recessed center, with the width of the plate section greater than the width of the frame block to form extended edge portions;
a skirt section protruding from each edge of said frame block;
a gasket layer positioned on said frame block for sealing the perimeter surface of the multi-well plate;
a plurality of primary guiding tabs protruding from said skirt section; and
a plurality of secondary guiding tabs protruding from said extended edge portions of said plate section.

13. The lid as recited in claim 12, wherein said gasket layer is incompressible when fitted onto said plate.

14. The lid as recited in claim 12, wherein said skirt section is taller than said gasket layer to form a protective wall and provide air flow blockage.

15. The lid as recited in claim 12, wherein said gasket is formed of a material chosen from a group consisting of viton rubber, silicon rubber, and buna rubber.

16. The lid as recited in claim 12, wherein said gasket layer is attached to said frame block through adhesive.

17. The lid as recited in claim 12, wherein said gasket layer is fitted onto said frame through friction.

18. The lid as recited in claim 12, wherein said gasket layer has a thickness that ranges from 0.0312 inches to 0.0625 inches.

19. The lid as recited in claim 12, wherein said gasket layer is flat and rectangular.

20. The lid as recited in claim 12, wherein the plate section has a plurality of through holes arranged in a matrix-like manner to allow gas exchange in a uniform manner.

21. The lid as recited in claim 12, wherein said gasket has a durometer value in the range of 20 A to 75 A, or a minimum tensile strength of 900 PSI.

22. A lid for covering a multi-well plate comprising:
a plate section dimensioned to cover said multi-well plate;
a frame block having one or more receiving recesses, said frame block positioned on the underside perimeter of said cover plate to form a recessed center;
a skirt section protruding from each edge of said frame block; and
a gasket layer having one or more protrusions for sealing the peripheral surface of the multi-well plate, wherein said one or more protrusions mates with each of said corresponding receiving recesses of said frame block.

23. The lid as recited in claim 22, wherein the plate section has a plurality of through holes arranged in a matrix-like manner to allow exchange of gas in a uniform manner.
